(19) United States
(12) Patent Application Publication
(10) Pub. No.: US 2013/0104082 A1
(43) Pub. Date: Apr. 25, 2013

(54) AUDIO/VISUAL DEVICE APPLICATIONS GRAPHICAL USER INTERFACE

(71) Applicants: Benjamin D. Burge, Shaker Heights, OH (US); Eric E. Dolecki, Framingham, MA (US); John Michael Sakalowsky, West Newton, MA (US)

(72) Inventors: Benjamin D. Burge, Shaker Heights, OH (US); Eric E. Dolecki, Framingham, MA (US); John Michael Sakalowsky, West Newton, MA (US)

(21) Appl. No.: 13/448,514

(22) Filed: Apr. 17, 2012

Related U.S. Application Data
(63) Continuation-in-part of application No. 12/769,355, filed on Apr. 28, 2010.
Application No. 12/769,355 is a continuation-in-part of application No. 12/613,945, filed on Nov. 6, 2009.

(51) Int. Cl. G06F 3/0482

(52) U.S. Cl. CPC G06F 3/0482
USPC 715/841

(57) ABSTRACT

A user interface for an audio/visual device incorporates a racetrack menu made up of menu items disposed about the periphery of a display element in which the visual display of at least one menu item is made up of submenu items of that one menu item that are disposed about the periphery of the visual display of that one menu item, and where navigation among the submenu items of that one menu item is effected in a manner that is substantially similar to the navigation of the menu items of the racetrack menu.

### CROSS-REFERENCE TO RELATED APPLICATIONS

The present application is a continuation-in-part of application Ser. No. 12/769,355 filed Apr. 28, 2010 by John M. Sakalowsky, Benjamin D. Burge and Eric E. Dolecki; which in turn, is a continuation-in-part of application Ser. No. 12/613,945 filed Nov. 6, 2009 by Santiago Carvajal, Eric E. Dolecki, Neil W. Griffiths, John M. Sakalowsky, Conor Sheehan and Benjamin D. Burge; the disclosures of both of which are incorporated herein by reference.

### TECHNICAL FIELD

This disclosure relates to user interfaces incorporating a visual display and/or a touch-sensitive control.

### BACKGROUND

Part of enjoying the playing of an audio/visual program (e.g., a piece of music, a recorded lecture, a recorded live performance, a movie, a slideshow, family pictures, an episode of a television program, etc.) is the task of selecting the desired audio/visual program to be played. Unfortunately, the increasing variety of choices of sources of audio/visual programs and the increasing variety of mechanisms by which audio/visual programs are able to be stored and played has greatly complicated what was once the relatively simple act of watching or listening to the playing of an audio/visual program to enjoy it.

For example, those wishing to “tune in” an audio/visual program being broadcast must now select a channel on which to view an audio/visual program from as many as 500 channels available through typical cable and/or satellite connections for television and/or radio. Further, it has become commonplace to employ audio/visual devices that are able to be programmed to autonomously tune in and record an audio/visual program for playing at a later time. Still further, it is now becoming increasingly commonplace to obtain audio/visual programs from websites accessible through the Internet. Yet further, some of these possible sources of audio/visual programs require paid subscriptions for which key cards and/or decryption keys are required to gain access to at least some audio/visual programs.

Those seeking to avail themselves of even a modest subset of such a wide array of options for playing an audio/visual program have often found themselves having to obtain multiple audio/visual devices (e.g., tuners, descramblers, disc media players, video recorders, web access devices, digital file players, televisions, visual displays without tuners, etc.). Each such audio/visual device often has a unique user interface, and more often than not, is accompanied by a separate handheld wireless remote control by which it is operated.

### SUMMARY

A user interface for an audio/visual device incorporates a racetrack menu made up of menu items disposed about the periphery of a display element in which the visual display of at least one menu item is made up of submenu items of that one menu item that are disposed about the periphery of the visual display of that one menu item, and where navigation among the submenu items of that one menu item is effected in a manner that is substantially similar to the navigation of the menu items of the racetrack menu.

In one aspect, an apparatus includes a processing device and a storage accessible to the processing device and storing a sequence of instructions. When that sequence of instructions is executed by the processing device, the processing device: causes a racetrack menu having a ring shape to be visually displayed on a display element about the periphery of the display element such that the racetrack menu surrounds a first display area of the display element in which a visual portion of an audio/visual program selected via the racetrack menu may be visually displayed such that the visual portion does not extend beyond the outer edge of the ring shape of the racetrack menu; causes a first plurality of menu items to be displayed in the racetrack menu, wherein the first plurality of menu items comprises a first menu item visually displayed as a submenu comprising a plurality of submenu items disposed about the periphery of the display of the first menu item; causes a first marker to be visually displayed in the racetrack menu; in response to an indication of a first manually-operable control being operated to move the first marker, moves the first marker about the racetrack menu, while constraining movement to within the racetrack menu; and in response to an indication of the first manually-operable control being operated to select the first menu item causes the first menu item to be selected, wherein causing the first menu item to be selected comprises further causing the processing device to cause the first marker to be displayed within the first menu item in the vicinity of a submenu item of the plurality of submenu items.

In another aspect, a method includes: visually displaying a racetrack menu having a ring shape on a display element about the periphery of the display element such that the racetrack menu surrounds a first display area of the display element in which a visual portion of an audio/visual program selected via the racetrack menu may be visually displayed such that the visual portion does not extend beyond the outer edge of the ring shape of the racetrack menu; visually displaying a first plurality of menu items in the racetrack menu, wherein the first plurality of menu items comprises a first menu item visually displayed as a submenu comprising a plurality of submenu items disposed about the periphery of the display of the first menu item; visually displaying a first marker in the racetrack menu;

in response to an indication of a first manually-operable control being operated to move the first marker, moving the first marker about the racetrack menu, while constraining movement to within the racetrack menu; and in response to an indication of the first manually-operable control being operated to select the first menu item causing the first menu item to be selected, wherein causing the first menu item to be selected comprises causing the first marker to be displayed within the first menu item in the vicinity of a submenu item of the plurality of submenu items.

Further, causing the first menu item to be selected may include expanding the visual display of the first menu item such that the first menu item extends into the first display area.

Other features and advantages of the invention will be apparent from the description and claims that follow.

### DESCRIPTION OF THE DRAWINGS

FIG. 1 is a perspective view of an embodiment of a user interface.

FIG. 2 depicts correlations between movement of a digit on a racetrack sensor of the user interface of FIG. 1 and movement of a marker on a racetrack menu of the user interface of FIG. 1, as well as well aspects of operation of navigation controls and movement of a second marker not on the racetrack menu.

FIG. 3 is a block diagram of a possible electrical architecture of the user interface of FIG. 1.

FIGS. 4, 5 and 6, together, depict additional possible details of the user interface of FIG. 1.

### DETAILED DESCRIPTION

What is disclosed and what is claimed herein is intended to be applicable to a wide variety of audio/visual devices, i.e., devices that are structured to be employed by a user to play an audio/visual program. It should be noted that although various specific embodiments of audio/visual devices (e.g., televisions, set-top boxes and hand-held remotes) are presented with some degree of detail, such presentations of specific embodiments are intended to facilitate understanding through the use of examples, and should not be taken as limiting either the scope of disclosure or the scope of claim coverage. It is intended that what is disclosed and what is claimed herein is applicable to audio/visual devices that employ a tuner and/or a network interface to receive an audio/visual program; that cooperate with other devices to play an audio/visual program and/or to cause an audio/visual program to be played; that are wirelessly connected to other devices; that are connected to other devices through electrically and/or optically conductive cabling; that are not connected to any other device, at all; and/or that are either portable or not. Still other configurations of audio/visual devices to which what is disclosed and what is claimed herein are applicable will be apparent to those skilled in the art.

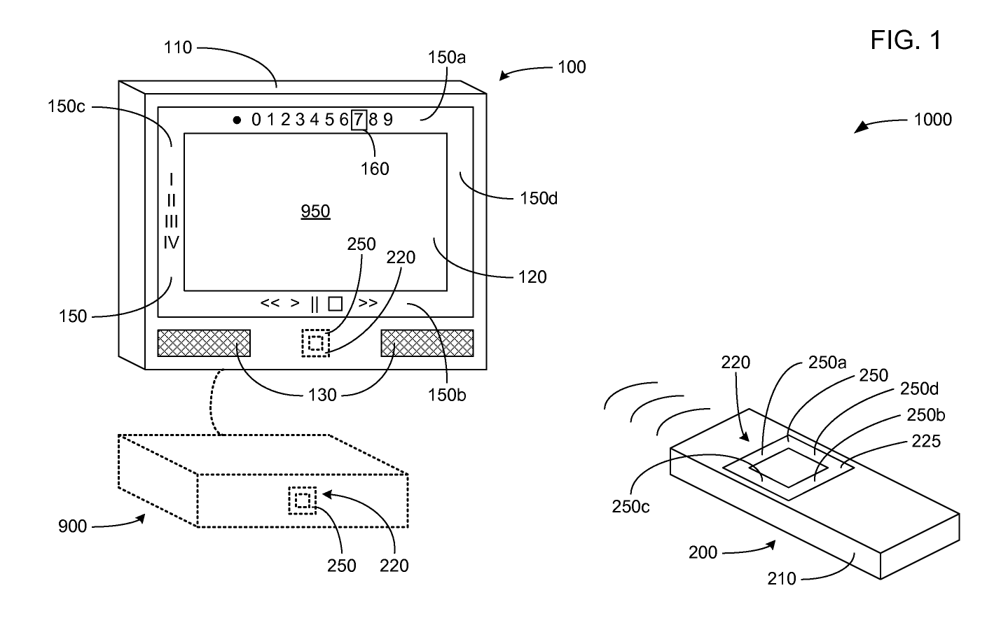

FIG. 1 depicts a user interface 1000 enabling a user's hand-eye coordination to be employed to more intuitively operate at least one audio/visual device to select and play an audio/visual program. The user interface 1000 incorporates a displayed “racetrack” menu 150 and a corresponding “racetrack” surface 250. As depicted, the user interface 1000 is implemented by an interoperable set of devices that include at least an audio/visual device 100 and a handheld remote control 200, and may further include another audio/visual device 900. However, as will be explained in greater detail, the user interface 1000 may be fully implemented by a single audio/visual device, such as the audio/visual device 100.

The racetrack menu 150 is visually displayed on a display element 120 disposed on a casing 110 of the audio/visual device 100, and as depicted, the audio/visual device 100 is a flat panel display device such as a television, employing a flat panel form of the display element 120 such as a liquid crystal display (LCD) element or a plasma display element. Further, the audio/visual device 100 may further incorporate acoustic drivers 130 to acoustically output sound. However, as those skilled in the art will readily recognize, the racetrack menu 150 may be displayed by any of a variety of types of audio/visual device, whether portable or stationary, including and not limited to, a projector or a handheld device.

The racetrack surface 250 is defined on a touch-sensitive surface 225 of a touch sensor 220 disposed on a casing 210 of the handheld remote control 200, and as depicted, the touch-sensitive surface 225 has a rectangular ring shape that physically defines the shape and position of the racetrack surface 250 such that the racetrack surface 250 encompasses substantially all of the touch-sensitive surface of the touch sensor 220. However, the touch sensor 220 may be incorporated into any of a wide variety of devices, whether portable or stationary, including and not limited to, a wall-mounted control panel or a keyboard. Further, it is also envisioned that the touch sensor 220 may have a variant of the touch-sensitive surface 225 that is of a shape other than a ring shape with the racetrack surface 250 defined on that variant of the touch-sensitive surface 225 in another way such that the racetrack surface 250 encompasses only a subset of that variant of the touch-sensitive surface 225.

As depicted, both the racetrack menu 150 and the racetrack surface 250 have a ring shape that is a generally rectangular ring shape with corresponding sets of four sides. More specifically, the four sides 150a, 150b, 150c and 150d of the racetrack menu 150 are arranged to correspond to the four sides 250a, 250b, 250c and 250d of the racetrack surface 250. This four-sided nature of both of the racetrack menu 150 and the racetrack surface 250 is meant to accommodate the rectilinear nature of the vast majority of display elements currently found in audio/visual devices and the rectilinear nature of the visual portion of the vast majority of currently existing audio/visual programs that have a visual portion. However, it is important to note that other embodiments are possible in which the ring shape adopted by the racetrack surface 250 has a circular ring shape, an oval ring shape, a hexagonal ring shape or still other geometric variants of a ring shape. Further, where the racetrack menu 150 and/or the racetrack surface 250 have a ring shape that is other than a rectangular ring shape, one or both of the display element 120 and the touch sensor 220 may, themselves, have a shape other than the rectangular shapes depicted herein.

In differing embodiments, the four sides 150a-d of the racetrack menu 150 may either surround or overlie the edges of a display area 950 in which the visual portion of an audio/visual program selected via the user interface 1000 may be played. Where a selected audio/visual program does not have a visual portion (e.g., the audio/visual program is an audio recording having only an audio portion), the display area 950 may remain blank (e.g., display only a black or blue background color) or may display status information concerning the playing of the selected audio/visual program while being played, perhaps with the audio portion being acoustically output by the acoustic drivers 130. As depicted, the four sides 150a-d of the racetrack menu 150 are displayed by the display element 120 at the edges of the display element 120. However, it is also envisioned that the four sides 150a-d of the racetrack menu 150 may be positioned about the edges of a “window” of a graphical user interface of the type commonly employed in the operation of typical computer systems, perhaps where the audio/visual device 100 is a computer system on which audio/visual programs are selected and played through the user interface 1000.

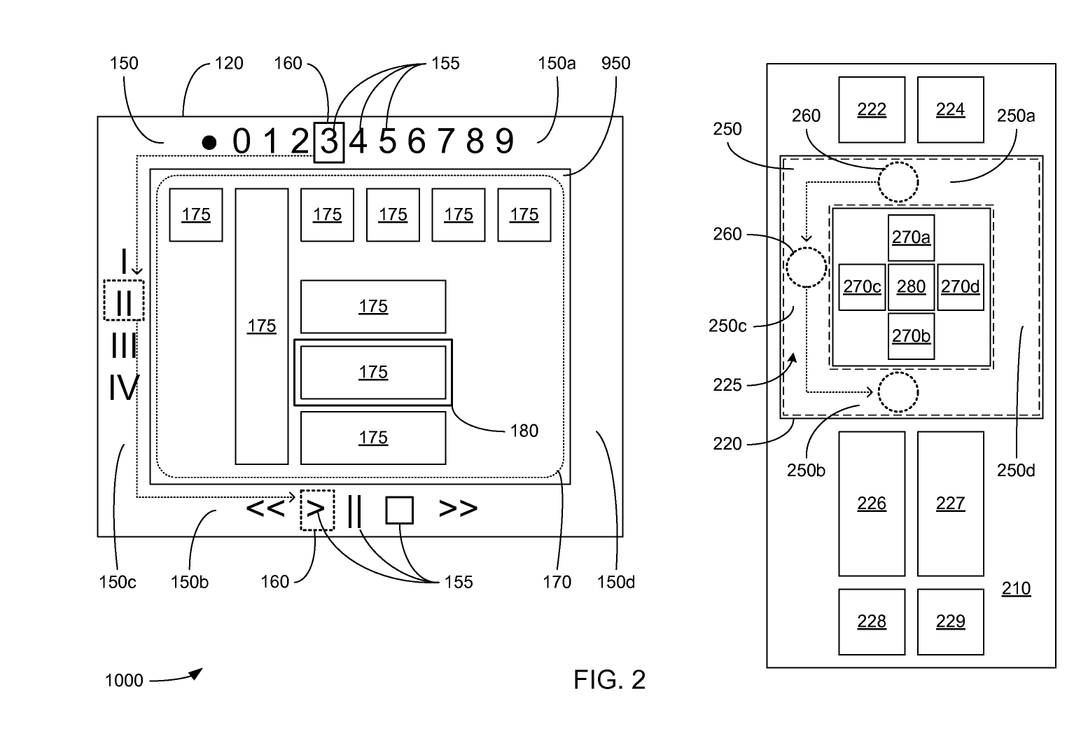

As shown in FIG. 2, at various positions along one or more of the four sides 150a-d of the racetrack menu 150 are menu items 155 that may be selected by a user of the user interface 1000. The menu items 155 may include alphanumeric characters (such as those depicted along the side 150a) that may be selected to specify a channel or a website from which to select and/or receive an audio/visual program, symbols (such as those depicted along the side 150b) representing commands to control the operation of an audio/visual device capable of playing an audio/visual program (e.g., “play” and “stop” commands for a video cassette recorder, a disc media player, or solid state digital file player, etc.), and indicators of inputs (such as those depicted along the side 150c) to an audio/visual device that may be selected and through which an audio/visual program may be selected and/or received. Although the various menu items 155 positioned along the racetrack menu 150 could conceivably serve any of a wide variety of purposes, it is envisioned that much of the functionality of the menu items 155 will be related to enabling a user to select an audio/visual program for playing, and/or to actually play an audio/visual program.

To operate the user interface 1000, a user places the tip of a digit of one of their hands (i.e., the tip of a thumb or finger) on a portion of the racetrack surface 250 defined on the touch-sensitive surface 225 of the touch sensor 220, and a marker 160 is displayed on a portion of the racetrack menu 150 that has a position on the racetrack menu 150 that corresponds to the position 260 on the racetrack surface 250 at which the tip of their digit is in contact with the touch-sensitive surface 225 of the touch sensor 220. FIG. 2 depicts how the marker 160 moves about and is constrained to moving about the racetrack menu 150 to maintain a correspondence between its location on the racetrack menu 150 and the position 260 of the digit on the racetrack surface 250 as the user moves that digit about the racetrack surface 250. In some embodiments, the marker 160 may move about the racetrack menu 150 in a manner in which the marker 160 “snaps” from being centered about one menu item 155 to an adjacent menu item 155 as the marker 160 is moved about a portion of the racetrack menu 150 having adjacent ones of the menu items 155. Further, such “snapping” of the marker 160 between adjacent ones of the menu items 155 may be accompanied by the concurrent acoustic output of some form of sound to provide further feedback to a user of the marker 160 moving from one such menu item 155 to another.

When the marker 160 is positioned over a menu item 155 that the user wishes to select, the user selects that menu item 155 by pressing whichever one of their digits that is already in contact with the racetrack surface 250 with greater pressure than was used in simply placing that digit in contact with the racetrack surface 250. A “click” or other sound accompanying the user's use of increased pressure on the racetrack surface 250 to select one of the menu items 155 may be acoustically output through an acoustic driver (not shown) incorporated into the remote control 200 and/or through the acoustic drivers 130.

Also depicted are additional controls 222, 224, 226, 227, 228 and 229 that may be employed to perform particular functions that may be deemed desirable to provide access to in a manner that does not require the selection of menu items to operate. In one possible variant, the controls 222, 224, 226, 227, 228 and 229 are operable as a power button, a source selection button, a volume rocker switch, a channel increment/decrement rocker switch, a mute button and a last channel return button, respectively. Where one of these additional controls is operable as a source selection button, its available use in selecting sources may be in addition to or in lieu of the provision of the ones of the menu items 155 depicted within side 150c as a mechanism for source selection.

As further depicted in FIG. 2, where a selected one of the sources 901-904 displays its own on-screen menu 170, either in place of a visual portion of an audio/visual program or overlying a visual portion of an audio/visual program, some embodiments of the user interface 1000 may support partly integrating the manner in which a user would navigate such an on-screen menu 170. In such embodiments, the touch sensor 220, with its ring shape (whether that ring shape is a rectangular ring shape, or a ring shape of a different geometry), may be configured to surround a set of controls for use in navigating the on-screen menu 170 just as the racetrack menu 150 surrounds the on-screen menu 170, itself.

In particular, the touch sensor 220 is depicted as being disposed on the casing 210 of the remote control 200 so as to surround navigation buttons 270a, 270b, 270c and 270d, as well as a selection button 280, that are also disposed on the casing 210. In alternate variants, other forms of one or more manually-operable controls may be surrounded by the touch sensor 220, in addition to or in place of the navigation buttons 270a-d and the selection button 280, including and not limited to, a joystick, or a four-way rocker switch that may either surround a selection button (such as the selection button 280) or be useable as a selection button by being pressed in the middle. As a result of the ring shape of the touch sensor 220 being employed to surround the navigation buttons 270a-d and the selection buttons 280, a nested arrangement of concentrically located manually operable controls is created. Depicted is an example form of possible on-screen menu that will be familiar to those skilled in the art, including various menu items 175 that may be selected via the selection button 280, and a marker 180 that may be moved by a user among the menu items 175 via the navigation buttons 270a-d. The concentrically nested arrangement of manually-operable controls surrounded by the racetrack surface 250 defined on the touch-sensitive surface 225 of the touch sensor 220 that is disposed on the casing 210 of the remote control 200 corresponds to the similarly nested arrangement of the on-screen menu 170 surrounded by the racetrack menu 150 that is displayed on the display element 120.

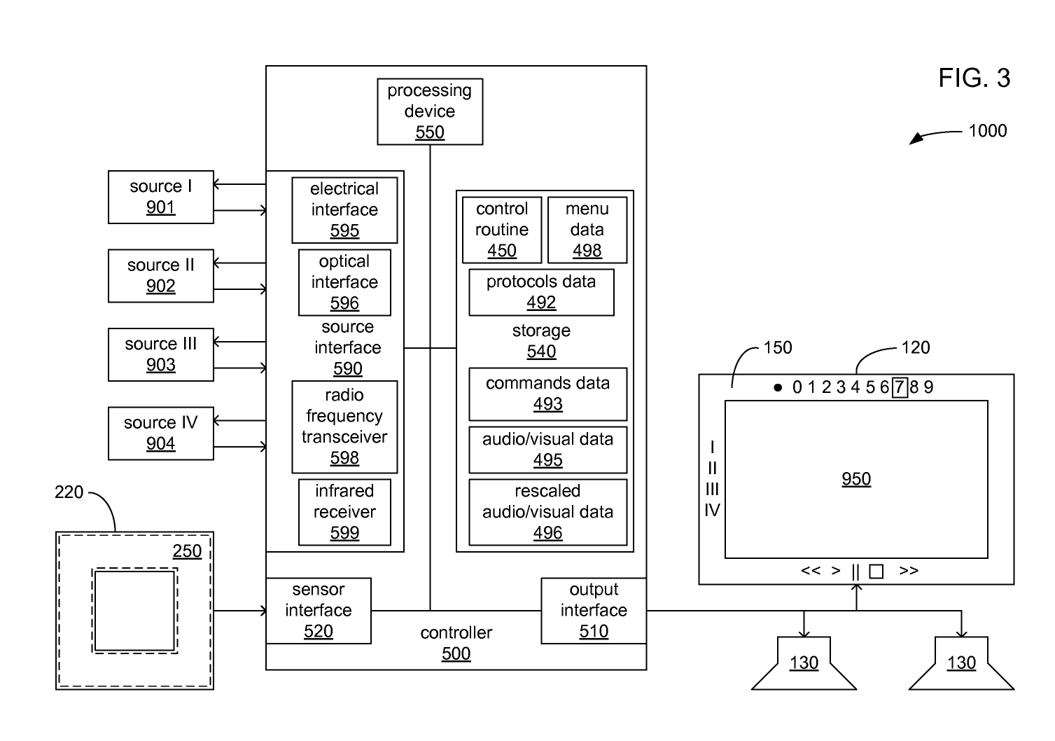

FIG. 3 is a block diagram of a possible electrical architecture by which the user interface 1000 may be provided. A controller 500 receives input through a user's use of at least the racetrack surface 250 defined on at least a portion of a touch-sensitive surface 225 of the touch sensor 220 to which the controller 500 is coupled, and provides at least the racetrack menu 150 as a visual output to the user through at least the display element 120 to which the controller 500 is also coupled. In various possible embodiments, the controller 500 may be incorporated directly into the audio/visual device 100, or into another audio/visual device 900 coupled to the audio/visual device 100 (shown in dotted lines in FIG. 1). As also depicted in FIG. 1, the remote control 200 communicates wireles sly through the emission of radio frequency, infrared or other wireless emissions to whichever one of the audio/visual devices 100 and 900 incorporates the controller 500. However, as those skilled in the art will readily recognize, the remote control 200 may communicate through an electrically and/or optically conductive cable (not shown) in other possible embodiments. Alternatively and/or additionally, the remote control 200 may communicate through a combination of wireless and cable-based (optical or electrical) connections forming a network between the remote control 200 and the controller 500. Still other embodiments may incorporate the touch sensor 220 directly on a user accessible portion of one or both of the audio/visual devices 100 and 900, either in addition to or as an alternative to providing the touch sensor 220 on the remote control 200.

The controller 500 incorporates multiple interfaces in the form of one or more connectors and/or one or more wireless transceivers by which the controller 500 is able to be coupled to one or more sources 901, 902, 903 and/or 904. Any such connectors may be disposed on the casing of whatever audio/visual device the controller 500 is incorporated into (e.g., the casing 110 of the audio/visual device 100 or a casing of the audio/visual device 900). In being so coupled, the controller 500 is able to transmit commands to one or more of the sources 901-904 to access and select audio/visual programs, and is able to receive audio/visual programs therefrom. Each of the sources 901-904 may be any of a variety of types of audio/visual device, including and not limited to, RF tuners (e.g., cable television or satellite dish tuners), disc media recorders and/or players, tape media recorders and/or players, solid-state or disk-based digital file players (e.g., a MP3 file player), Internet access devices to access streaming data of audio/visual programs, or docking cradles for portable audio/visual devices (e.g., a digital camera). Further, in some embodiments, one or more of the sources 901-904 may be incorporated into the same audio/visual device into which the controller 500 is incorporated (e.g., a built-in disc media player or built-in radio frequency tuner such that there would be no connector for it disposed on a casing). Still further, although each of the sources 901-904 is depicted as being directly coupled to the controller 500 in a point-to-point manner, those skilled in the art will readily recognize that one or more of the sources 901-904 may be coupled to the controller 500 indirectly through one or more of the others of the sources 901-904, or through a network formed among the sources 901-904 (and possibly incorporating routers, bridges and other relaying devices that will be familiar to those skilled in the art) with multiple cabling-based and/or wireless couplings.

Various industry standards for coupling audio/visual devices include specifications of commands that may be transmitted between audio/visual devices to control access to and/or control the playing of audio/visual programs. Where such an industry standard for coupling the controller 500 to one or more of the sources 901-904 is employed, the controller 500 may limit the commands transmitted to one or more of the sources 901-904 to the commands specified by that industry standard and map one or more of those commands to corresponding ones of the menu items 155 such that a user is able to cause the controller 500 to send those commands to one or more of the sources 901-904 by selecting those corresponding ones of the menu items 155. However, where such a standardized command set is unavailable, the controller 500 may employ any of a wide variety of approaches to identify one or more of the sources 901-904 to an extent necessary to “learn” what commands are appropriate to transmit and the manner in which they must be transmitted.

A user of the user interface 1000 may select one of the sources 901-904 as part of selecting an audio/visual program for being played by employing the racetrack surface 250 and the marker 160 to select one or more of the menu items 155 shown on the racetrack menu 150, such as the “I” through “IV” menu items 155 depicted as displayed by the controller 500 on the side 150c of the racetrack menu 150. Those menu items 155 depicted on the side 150c correspond to the sources 901 through 904, which are depicted as bearing “source I” through “source IV” as labels. The controller 500 receives input from the touch sensor 220 indicating the contact of the user's digit with a portion of the racetrack surface 250, indicating movement of the position 260 of contact of the digit about the racetrack surface 250, and indicating the application of greater pressure by the user through that digit against the touch sensor 220 at the position 260 (wherever the position 260 is at that moment) when selecting one of the menu items 155. The selection of one of the sources 901-904 by the user causes the controller 500 to switch to receiving audio/visual programs from that one of the sources 901-904, and to be ready to display any visual portion in the display area 950 and acoustically output any audio portion through the acoustic drivers 130 (or whatever other acoustic drivers may be present and employed for playing audio portions).

The selection of one of the sources 901-904 may further cause the controller 500 to alter the quantity and types of menu items 155 displayed on one or more of the sides 150a-d of the racetrack menu 150 such that the displayed menu items 155 more closely correspond to the functions supported by whichever one of the sources 901-904 that has been selected. By way of example, where one of the sources 901-904 that is able to record an audio/visual program was previously selected, the racetrack menu 150 may include one or more menu items 155 that could be selected to cause the controller 500 to transmit a command to that previously selected one of the sources 901-904 to cause it to start recording an audio/visual program. However, if the user then selects another one of the sources 901-904 that does not have the ability to record an audio/visual program, then the controller 500 would alter the menu items 155 displayed on the racetrack menu 150 to remove one or more menu items associated with recording an audio/visual program. In this way, at least a subset of the menu items 155 displayed on the racetrack menu 150 are “modal” in nature, insofar as at least that subset changes with the selection of different ones of the sources 901-904. Also, the coupling and/or uncoupling of one or more of the sources 901-904 to and/or from whatever audio/visual device into which the controller 500 is incorporated may also cause the controller 500 to alter the quantity and/or types of menu items 155 that are displayed in another example of at least a subset of the menu items 155 being modal in nature.

While at least some of the menu items 155 may be modal in nature such that they are apt to change depending on the selection and/or condition of one or more of the sources 901-904, others of the menu items 155 may not be modal in nature such that they are always displayed whenever the racetrack menu 150 is displayed. More specifically, where one or more of the sources 901-904 are incorporated into the same audio/visual device as the controller 500, the ones of the menu items 155 associated with those sources may remain displayed in the racetrack menu 150, regardless of the occurrences of many possible events that may cause other menu items 155 having a modal nature to be displayed, to not be displayed, or to be displayed in some altered form.

FIG. 3 also provides a block diagram of a possible architecture of the controller 500 that may be employed within the larger electrical architecture depicted in FIG. 3. As depicted, the controller 500 incorporates an output interface 510, a sensor interface 520, a storage 540, a processing device 550 and a source interface 590. The processing device 550 is coupled to each of the output interface 510, the sensor interface 520, the storage 540 and the source interface 590 to at least coordinate the operation of each to perform at least the above-described functions of the controller 500.

The processing device 550 may be any of a variety of types of processing device based on any of a variety of technologies, including and not limited to, a general purpose central processing unit (CPU), a digital signal processor (DSP), a microcontroller, or a sequencer. The storage 540 may be based on any of a variety of data storage technologies, including and not limited to, any of a wide variety of types of volatile and nonvolatile solid-state memory, magnetic media storage, and/or optical media storage. It should be noted that although the storage 540 is depicted in a manner that is suggestive of it being a single storage device, the storage 540 may be made up of multiple storage devices, each of which may be based on different technologies.

Each of the output interface 510, the sensor interface 520 and the source interface 590 may employ any of a variety of technologies to enable the controller 500 to communicate with other devices and/or other components of whatever audio/visual device into which the controller 500 is incorporated. More specifically, where the controller 500 is incorporated into an audio/visual device that also incorporates one or both of a display element (such as the display element 120) and at least one acoustic driver (such as the acoustic drivers 130), the output interface 510 may be of a type able to directly drive a display element, and/or able to directly drive one or more acoustic drivers. Alternatively, where one or both of a display element and acoustic drivers are not incorporated into the same audio/visual device into which the controller 500 is incorporated, the output interface 510 may be of a type employing cabling-based and/or a wireless signaling to transmit a signal to another audio/visual device into which a display element and/or acoustic drivers are incorporated.

Similarly, where the controller 500 is incorporated into an audio/visual device into which the touch sensor 220 is also incorporated, the sensor interface 520 may be of a type able to directly receive electrical signals emanating from the touch sensor 220. With such a more direct coupling, the sensor interface 520 may directly monitor a two-dimensional array of touch-sensitive points of the touch-sensitive surface 225 of the touch sensor 220 for indications of which touch-sensitive points are being touched by a tip of a user's digit, and thereby enable the processing device 550 to employ those indications to directly determine where the touch-sensitive surface 225 is being touched. Thus, a determination of whether or not the tip of the digit is touching a portion of the racetrack surface 250 and/or the position 260 by the processing device 550 may be enabled. However, where the controller 500 is incorporated into a device into which the touch sensor 220 is not also incorporated (e.g., the controller 500 is incorporated into the audio/visual device 100 and the touch sensor is incorporated into the remote control 200), the sensor interface 520 may be of a type able to receive cabling-based and/or wireless signaling transmitted by that other device (e.g., infrared signals emitted by the remote control 200). With such a more remote coupling, circuitry (not shown) that is co-located with the touch sensor 220 may perform the task of directly monitoring a two-dimensional array of touch-sensitive points of the touch-sensitive surface 225, and then transmit indications of which touch-sensitive points are being touched by the tip of a user's digit to the sensor interface 520.

Although it is possible that the audio/visual device into which the controller 500 is incorporated may not incorporate any sources (such as the sources 901-904) from which the controller 500 receives audio/visual programs, it is deemed more likely that the audio/visual device into which the controller 500 is incorporated will incorporate one or more of such sources in addition to being capable of receiving audio/visual programs from sources not incorporated into the same audio/visual device. By way of example, it is envisioned that the controller 500 may be incorporated into an audio/visual device into which a radio frequency tuner and/or an Internet access device is also incorporated to enable access to audio/visual programs for selection and playing without the attachment of another audio/visual device, while also having the capability of being coupled to another audio/visual device to receive still other audio/visual programs.

Thus, the source interface 590 incorporates one or more of an electrical interface 595, an optical interface 596, a radio frequency transceiver 598 and/or an infrared receiver 599. The electrical interface 595 (if present) enables the source interface 590 to couple the controller 500 to at least one source, whether incorporated into the same audio/visual device as the controller 500, or not, to receive electrical signals conveying an audio/visual program to the controller 500. The optical interface 596 (if present) enables the source interface 590 to couple the controller 500 to at least one source to receive optical signals conveying an audio/visual program to the controller 500. The radio frequency transceiver 598 (if present) enables the source interface 590 to wirelessly couple the controller 500 to at least one other audio/visual device functioning as a source to receive radio frequency signals conveying an audio/visual program to the controller 500 from that other audio/visual device. The infrared receiver 599 (if present) enables the source interface 590 to wirelessly couple the controller 500 to at least one other audio/visual device functioning as a source to receive infrared signals conveying an audio/visual program to the controller 500 from that other source. It should be noted that although the output interface 510 and the sensor interface 520 are depicted as separate from the source interface 590, it may be deemed advantageous, depending on the nature of the signaling supported, to combine one or both of the output interface 510 and the sensor interface 520 with the source interface 590.

Stored within the storage 540 are one or more of a control routine 450, a protocols data 492, a commands data 493, an audio/visual data 495, a rescaled audio/visual data 496, and menu data 498. Upon being executed by the processing device 550, a sequence of instructions of the control routine 450 causes the processing device 550 to coordinate the monitoring of the touch sensor 220 for user input, the output of the racetrack menu 150 to a display element (e.g., the display element 120), the selection of a source of an audio/visual program to be played, and one or both of the display of a visual portion of an audio/visual program on a display element on which the racetrack menu 150 is also displayed and the acoustic output of an audio portion of the audio/visual program via one or more acoustic drivers (e.g., the acoustic drivers 130).

Upon execution, the control routine 450 causes the processing device 550 to operate the sensor interface 520 to await indications of a user placing a tip of a digit in contact with a portion of the racetrack surface 250 defined on a surface of the touch sensor 220, moving that digit about the racetrack surface 250 and/or applying greater pressure at the position 260 on the racetrack surface 250 to make a selection. Upon receiving an indication of activity by the user involving the racetrack surface 250, the processing device 550 may be caused to operate the output interface 510 to display the racetrack menu 150 with one or more of the menu items 155 positioned thereon and surrounding the display area 950 via a display element, if the racetrack menu 150 is not already being displayed. The processing device 550 is further caused to display and position at least the marker 160 on the racetrack menu 150 in a manner that corresponds to the position 260 of the user's digit on the racetrack surface 250. Further, in response to the passage of a predetermined period of time without receiving indications of activity by the user involving the racetrack surface 250, the processing device 550 may be caused to operate the output interface 510 to cease displaying the racetrack menu 150, and to display substantially little else on a display element than the display area 950.

As previously mentioned, in some embodiments, at a time when both the display area 950 and the racetrack menu 150 are displayed, the controller 500 reduces the size of the display area 950 to make room around the edges of the display area 950 for the display of the racetrack menu 150 on the display element 120, and in so doing, may rescale the visual portion (if there is one) of whatever audio/visual program may be playing at that time. In other embodiments, the display area 950 is not resized, and instead, the racetrack menu 150 is displayed in a manner in which the racetrack menu 150 overlies edge portions of the display area 950 such that edge portions of any visual portion of an audio/visual program are no longer visible. However, in those embodiments in which the racetrack menu overlies edge portions of the display area 950, the racetrack menu 150 may be displayed in a manner in which at least some portions of the racetrack menu have a somewhat “transparent” quality in which the overlain edge portions of any visual portion of an audio/visual program can still be seen by the user “looking through” the racetrack menu 150.

Upon execution, the control routine 450 causes the processing device 550 to operate the sensor interface 520 to await an indication of a selection of a menu item 155 that corresponds to selecting a source from which the user may wish an audio/visual program to be provided for playing, and may operate the source interface 590 to at least enable receipt of an audio/visual program from that selected source. Where an audio/visual program is received, the processing device 550 may be further caused to buffer audio and/or visual portions of the audio/visual program in the storage 540 as the audio/visual data 495. In embodiments in which a visual portion of an audio/visual program is rescaled to be displayed in the display area 950 at a time when the display area 950 is surrounded by the racetrack menu 150, the processing device 550 may be further caused to buffer the rescaled form of the visual portion in the storage 540 as the rescaled audio/visual program data 496.

Upon execution, the control routine 450 causes the processing device 550 to operate the sensor interface 520 to await an indication of a selection of a menu item 155 corresponding to the selection of a command (e.g., “play” or “record” commands, numerals or other symbols specifying a radio frequency channel to tune, etc.) to be transmitted to an audio/visual device serving as a source, and may operate the source interface 590 to transmit a command to that audio/visual device (e.g., one of sources 901-904) that corresponds to a menu item 155 that has been selected. In transmitting that command, the processing device 550 may be further caused to refer to the protocols data 492 for data concerning sequences of signals that must be transmitted by the source interface 590 as part of a communications protocol in preparation for transmitting the command, and/or the processing device 550 may be further caused to refer to the commands data 493 for data concerning the sequence of signals that must be transmitted by the source interface 590 as part of transmitting the command. As will be familiar to those skilled in the art, various industry-standardized forms of coupling between audio/visual devices make use of various protocols to organize various aspects of commands and/or data that are conveyed. In support of the processing device 550 responding to the selection of various ones of the menu items 155, the processing device 550 is further caused to store data correlating at least some of the various menu items with actions to be taken by the processing device 550 in response to their selection by the user in the storage 540 as the menu data 498.

Amidst operating the source interface 590 to enable receipt of an audio/visual program from a source selected by the user, the processing device 550 may be caused to operate the output interface 510 to alter the quantity and/or type of menu items 155 that are displayed at various positions on the racetrack menu 150. In so doing, the processing device 550 may be further caused to store information concerning the size, shape, color and other characteristics of the racetrack menu 150, at least some of the graphical representations of the menu items 155, and/or at least one graphical representation of the marker 160 in the storage 540 as part of the menu data 498.

In some embodiments, at a time when the racetrack menu 150 is not displayed (e.g., at a time when only the display area 950 is displayed), the controller 500 may do more than simply cause the racetrack menu 150 to be displayed in response to a user touching a portion of the racetrack sensor 250. More specifically, in addition to causing the racetrack menu 150 to be displayed, the controller 500 may take particular actions in response to particular ones of the sides 250a-d of the racetrack surface 250 being touched by a user at a time when the racetrack menu 150 is not being displayed. In a variation of such embodiments, it may be that causing the racetrack menu 150 to be displayed requires both a touch and some minimum degree of movement of the tip of a user's digit on the racetrack surface 250 (i.e., a kind of “touch-and-drag” or “wiping” motion across a portion of the racetrack surface 250), while other particular actions are taken in response to where there is only a touch of a tip of a user's digit on particular ones of the sides 250a-d of the racetrack sensor 250.

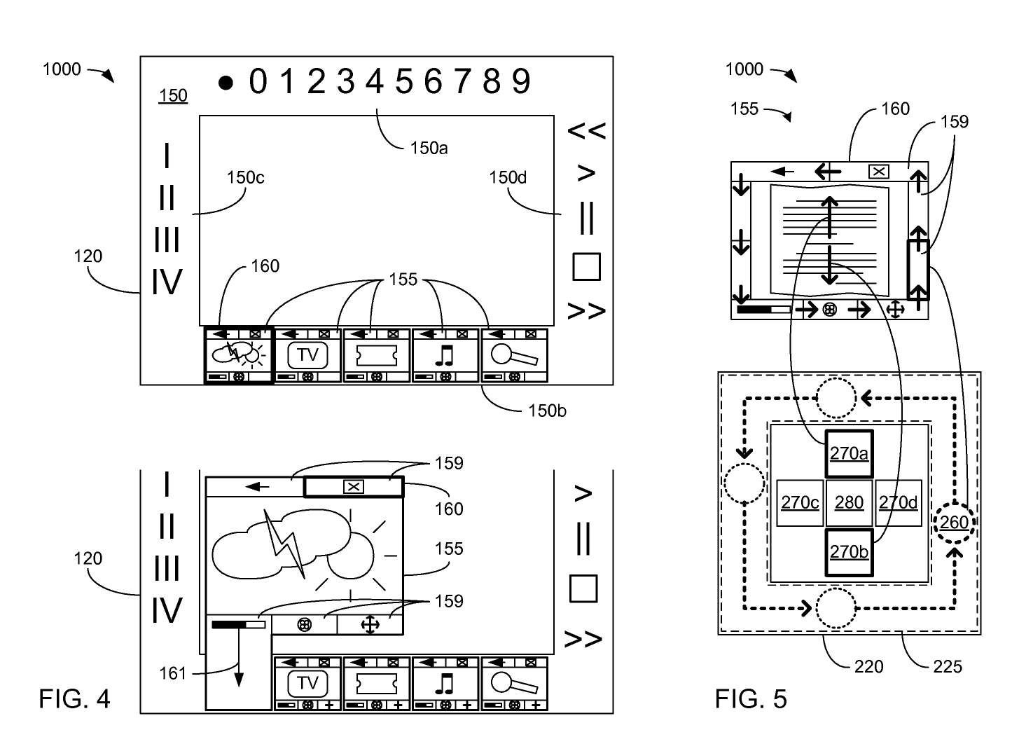

FIGS. 4, 5 and 6 depict additional features that may be incorporated into the user interface 1000, in which one or more submenus 151 of the racetrack menu 150 are supported. Provision may be made for one or more submenus 151 to enable a user of the user interface 1000 to control aspects of the operation of one or more audio/visual devices that do not require frequent user interaction, or to interact with applets or other such extensions to the functionality of whatever audio/visual device provides the user interface 1000. More specifically, with the increasing tendency to couple audio/visual devices to networks, including the Internet, to acquire audio/visual programs for playing, there has been a corresponding tendency to add various small-scale informational functions (frequently called “applets”) to audio/devices to, for example, enable audio/visual devices to be employed to obtain and display weather forecasts, stock quotes and news, as well as to enable audio/visual devices to be used, for example, to purchase tickets to live performances or to engage in online auctions and videophone calls. Thus, what is depicted in FIGS. 4, 5 and 6 are aspects of an approach to extending the user interface 1000 to accommodate such added functions.

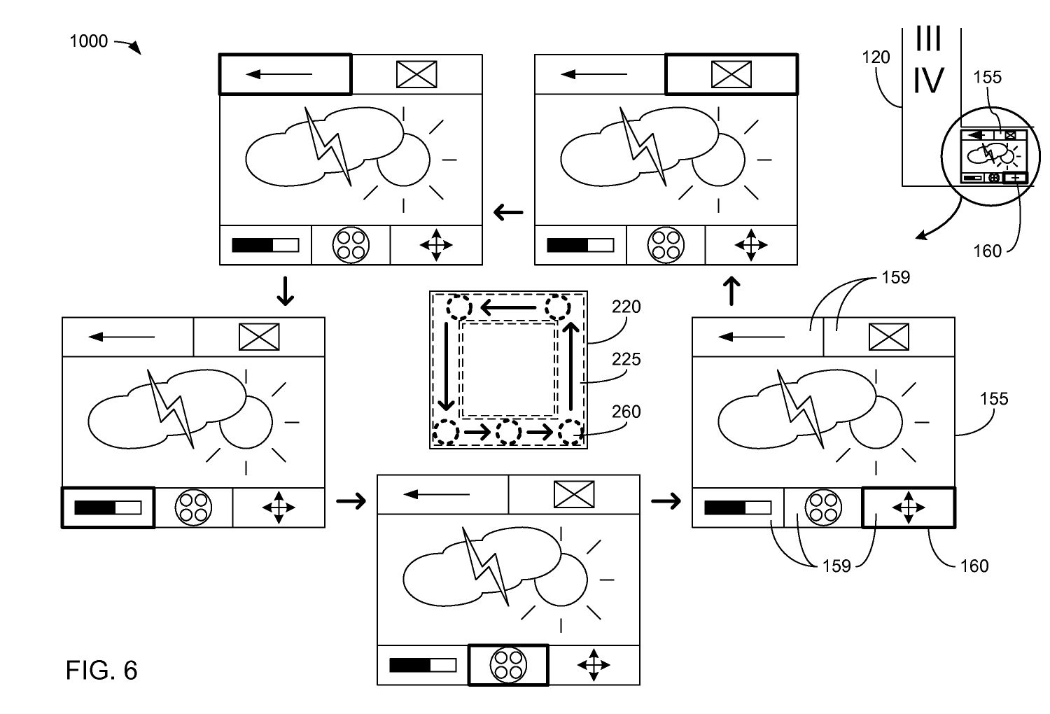

FIG. 4 depicts a variant of the example of racetrack menu 150 presented in FIGS. 1-3 in which some of the menu items 155 (specifically those disposed along side 150b) are of considerably greater visual complexity than the others that have heretofore been depicted. As can be more clearly seen in FIG. 6, this added complexity arises from the fact that each of these particular menu items 155 is actually a submenu onto itself, with a set of submenu items 159 to choose from. FIGS. 4 and 6 depict two possible variations of a response to a user selecting one of these more visually complex menu items 155 (specifically, a menu item 155 for a weather forecast applet). Specifically, FIG. 4 depicts one possible response in which this particular menu item 155 being visually expanded into the display area 950, and the marker 160 being moved from being positioned within the racetrack menu 150 to being positioned within the expanded form of this particular menu item 155 such that the marker 160 is able to be moved among multiple submenu items 159. Also specifically, FIG. 6 depicts another possible response in which little is changed in the visual display of this particular menu item 155 other than the marker 160 being resized and repositioned for being moved among the submenu items 159 making up the visual presentation of this particular menu item 155—in other words, the marker 160 becomes constrained to moving within only this particular menu item 155 as it remains disposed in place along the racetrack menu 150.

FIG. 6 depicts this particular menu item 155 in magnified form and depicts the marker 160 moving among its submenu items 159 as a tip of a digit is moved about the racetrack surface defined 250 defined on the touch-sensitive surface 225 of the touch sensor 220 in a manner very much like what has already been described, at length, with regard to movement of the marker 160 among menu items 155 disposed along the racetrack menu 150. However, it should be noted that it is envisioned that this same type of movement also occurs where this particular menu item 155 is expanded into the display area 950, as depicted in FIG. 4. The placement of the submenu items 159 is about the periphery of the visual display 155 in each of FIGS. 4 and 6 in a manner that is also meant to correspond to the placement of the menu items 155 along the racetrack menu 150 about the periphery of the display element 120. Indeed, it is intended that the manner in which a user would navigate about such a menu item 155 having submenu items 159 (moving the marker 160 about a periphery) would be quite similar to the manner in which a user would navigate about the menu items 155 of the racetrack menu 150, thus providing a consistent user experience.

Thus, referring variously to FIGS. 4 and 6, to enable the navigation of the submenu formed by the submenu items 159 of one or more of the menu items 155, the racetrack surface 250 defined on the touch-sensitive surface 225 of the touch sensor 220 is monitored (perhaps by the processing device 550 of the controller 500 as a result of executing the control routine 450) at a time when the racetrack menu 150 is being displayed for an instance of a user positioning a tip of a digit over a position on the racetrack surface 250 that corresponds to one of the menu items 155 that incorporates submenu items 159 (e.g., the one of the menu items for obtaining a weather forecast), and presses harder to select that one of the menu items 155. As has been previously explained, the marker 160 ceases to be displayed as moving among the menu items 155 of the racetrack menu 150, and is repositioned to move among the submenu items 159 of the selected one of the menu items 155 in a manner that maintains a position that generally corresponds to the position at which that tip of a digit is in contact with the racetrack surface 250. In FIG. 4, this repositioning of the marker 160 happens in an expanded display of the selected one of the menu items 155, and in FIG. 6, this repositioning happens within the selected one of the menu items 155 as it remains in its position along the racetrack menu 150.

FIG. 6 more clearly depicts an example of such movement of the marker 160 among the submenu items 159 of the selected one of the menu items 155 in a counter-clockwise motion as the controller 500 (perhaps the processing device 550 as a result of executing the control program 450) adjusts the position of the marker 160 among these submenu items 159 to reflect the current position 260 of the tip of a digit of a user along the racetrack surface 250 defined on the touch-sensitive surface 225 of the touch sensor 220. Among these submenu items 159 is one submenu item 159 that, when selected, at least causes the marker 160 to be returned to being positioned for movement among the menu items 155 of the racetrack menu 150. In FIG. 4, where the selected one of the menu items 155 incorporating these submenu items 159 was expanded in its visual presentation, a possible additional marker 161 is depicted as providing an additional indication of which submenu 159 would need to be selected to cause this to occur.

As has been previously described, when displayed, the racetrack menu 150 may overlie the periphery of the display area 950, or the display area 950 may be resized to fit within the portion of the display element 120 that is surrounded by the racetrack menu 150. In variants in which a menu item 155 having submenu items 159 is expanded (as depicted in FIG. 4) in response to be being selected, the expanded display of that menu item 155 may also either overlie a portion of the display area 950, or the display area 950 may be resized to a subset of its normal size to fit within a portion of the display element 120 that is not employed in displaying either the racetrack menu 150 or the expanded presentation of that selected menu item 155. Alternatively, either overlying the display area 950 with both of the racetrack menu 150 and the selected one of the menu items 155 or resizing the display area 950 to fit within the smaller remaining portion of the display element 120 may be deemed to be too much overlying coverage over the display area 950 or to provide too little usable display area. And therefore, it may be that the display area 950 is simply not displayed when a menu item 155 having submenu items 159 is displayed in expanded form.

In some embodiments, it may be that the controller 500 monitors at least the touch sensor 220 for the passage of a predetermined period of time since there was activity on the part of a user of the user interface 1000 since a menu item 155 having submenu items 159 was selected such that the marker 160 was repositioned to move among those submenu items 159. In response to such a predetermined period of time of inactivity being reached, the marker 160 may be repositioned for movement among the menu items 155 (and where that particular menu item 159 was being depicted in expanded form, that particular menu item 155 may be returned to its normal size depiction along the racetrack menu 150). It may then be that after a second predetermined period of time has passed in which there has continued to be such inactivity, the entire racetrack menu 150 may cease to be displayed, such that there is a “staged” return to the display of no portion of the user interface 1000.

FIG. 5 depicts a newsreader applet example of a menu item 155 having numerous submenu items 159, and the manner in movement of the maker 160 among its submenu items 159 corresponds to movement of the position 260 of a tip of a digit about the racetrack surface 250. Again, multiple submenu items 159 are disposed about the periphery of the visual display of this menu item 155, though there are more of them in this example, causing a fuller population of available space about the periphery of the visual display of this example newsreader applet menu item 155 than the earlier weather applet example. Yet, the manner a user navigates about the submenu items 159 remains the same. Given the function of this particular example applet (i.e., reading news texts), it is envisioned that a scrollable column of news text is presented within the visual display of this menu item 155, with its submenus surrounding it in much the same way as the racetrack menu 150 surrounds the display area 950. Also, similar to the navigation controls surrounded by the racetrack surface 250 (e.g., the navigation buttons 270a-d and the selection button 280) being used to navigate a source menu system (e.g., the menu 170) at time when the marker is positioned for movement about the racetrack menu 150, the navigation controls may be used to navigate the news text, itself (e.g., to scroll through the news text). In this way the corresponding concentric control and concentric display of a menu surrounding a displayed item (whether a visual portion of an audio/visual program or a visual portion of an applet) is consistent across both situations—the racetrack surface 250 is used to move the marker 160 about a periphery surrounding an area, and the navigation controls are used to navigate within the area that is surrounded.

Other implementations are within the scope of the following claims and other claims to which the applicant may be entitled.

1. An apparatus comprising:
a processing device; and
a storage accessible to the processing device and storing a sequence of instructions that when executed by the processing device, causes the processing device to:
cause a racetrack menu having a ring shape to be visually displayed on a display element about the periphery of the display element such that the racetrack menu surrounds a first display area of the display element in which a visual portion of an audio/visual program selected via the racetrack menu may be visually displayed such that the visual portion does not extend beyond the outer edge of the ring shape of the racetrack menu;
cause a first plurality of menu items to be displayed in the racetrack menu, wherein the first plurality of menu items comprises a first menu item visually displayed as a submenu comprising a plurality of submenu items disposed about the periphery of the display of the first menu item;
cause a first marker to be visually displayed in the racetrack menu;
in response to an indication of a first manually-operable control being operated to move the first marker, move the first marker about the racetrack menu, while constraining movement to within the racetrack menu; and
in response to an indication of the first manually-operable control being operated to select the first menu item cause the first menu item to be selected, wherein causing the first menu item to be selected comprises further causing the processing device to cause the first marker to be displayed within the first menu item in the vicinity of a submenu item of the plurality of submenu items.

2. The apparatus of claim 1, wherein in response to an indication of the first manually-operable control being operated to move the first marker and in response to the first marker being caused to be displayed within the first menu item, the processing device is further caused to move the first marker about the submenu items of the plurality of submenu items of the first menu item, while constraining movement to within the first menu item and about the periphery of the display of the first menu item.

3. The apparatus of claim 2, wherein in response to the first marker being caused to be displayed within the first menu item and in response to an indication of the first manually-operable control being operated to select a first submenu item of the plurality of submenu items, the processing device is further caused to cause the first menu item to cease to be selected, wherein causing the first menu item to cease to be selected comprises causing the first marker to be movable about the racetrack menu and not among the submenu items.

4. The apparatus of claim 3, wherein causing the first menu item to be selected further comprises expanding the visual display of the first menu item such that the first menu item extends into the first display area.

5. The apparatus of claim 4, wherein the racetrack menu and the expanded visual display of the first menu item, together, surround and define a second display area occupying a subset of the first display area that is not overlain by the expanded visual display of the first menu item, and wherein the visual portion of the audio/visual program is resized and displayed entirely within the second display area.

6. The apparatus of claim 3, wherein causing the first menu item to cease to be selected comprises ceasing to visually display the first menu item as expanded into the first display area and to return to displaying the first menu item entirely within the racetrack menu.

7. The apparatus of claim 2, wherein the processing device is further caused to cause the first marker to be moved among the submenu items in a manner in which the first marker snaps between being in the vicinity of one submenu item of the plurality of submenu items and being in the vicinity of another submenu item of the plurality of submenu items.

8. The apparatus of claim 7, wherein the processing device is further caused to operate an acoustic driver to acoustically output a sound at each instance of the first marker snapping between the vicinities of the one and another submenu items.

9. The apparatus of claim 2, further comprising the first manually-operable control, wherein the first manually-operable control is a touch sensor having a touch-sensitive surface that is operable with a digit of a hand and on which is defined a racetrack surface that corresponds in shape to the racetrack menu.

10. The apparatus of claim 9, further comprising a second manually-operable control surrounded by the racetrack surface, wherein:
the second manually-operable control enables movement of a second marker about menu items of a second plurality of menu items displayed within the first display area at a time when the first manually operable control enables movement of the first marker about the racetrack menu; and
the second manually-operable control enables navigation within a portion of the first menu item that is at least partially surrounded by the plurality of submenu items about the periphery of the display of the first menu item at a time when the first menu item is selected and the first manually operable control enables movement of the first marker among the submenu items of the plurality of submenu items.

11. The apparatus of claim 2, wherein in response to the first marker being caused to be displayed within the first menu item and in response to a first predetermined period of time elapsing since the an indication of at least the first manually-operable control being operated was received, the processing device is further caused to cause the first menu item to cease to be selected, wherein causing the first menu item to cease to be selected comprises causing the first marker to cease to be movable among the submenu items.

12. A method comprising:
visually displaying a racetrack menu having a ring shape on a display element about the periphery of the display element such that the racetrack menu surrounds a first display area of the display element in which a visual portion of an audio/visual program selected via the racetrack menu may be visually displayed such that the visual portion does not extend beyond the outer edge of the ring shape of the racetrack menu;
visually displaying a first plurality of menu items in the racetrack menu, wherein the first plurality of menu items comprises a first menu item visually displayed as a submenu comprising a plurality of submenu items disposed about the periphery of the display of the first menu item;
visually displaying a first marker in the racetrack menu;
in response to an indication of a first manually-operable control being operated to move the first marker, moving the first marker about the racetrack menu, while constraining movement to within the racetrack menu; and
in response to an indication of the first manually-operable control being operated to select the first menu item causing the first menu item to be selected, wherein causing the first menu item to be selected comprises causing the first marker to be displayed within the first menu item in the vicinity of a submenu item of the plurality of submenu items.

13. The method of claim 12, further comprising in response to an indication of the first manually-operable control being operated to move the first marker and in response to the first marker being caused to be displayed within the first menu item, moving the first marker about the submenu items of the plurality of submenu items of the first menu item, while constraining movement to within the first menu item and about the periphery of the display of the first menu item.

14. The method of claim 13, further comprising in response to the first marker being caused to be displayed within the first menu item and in response to an indication of the first manually-operable control being operated to select a first submenu item of the plurality of submenu items, the causing the first menu item to cease to be selected, wherein causing the first menu item to cease to be selected comprises causing the first marker to be movable about the racetrack menu and not among the submenu items.

15. The method of claim 14, wherein causing the first menu item to be selected further comprises expanding the visual display of the first menu item such that the first menu item extends into the first display area.

16. The method of claim 15, wherein the racetrack menu and the expanded visual display of the first menu item, together, surround and define a second display area occupying a subset of the first display area that is not overlain by the expanded visual display of the first menu item, and the method further comprises resizing the visual portion of the audio/visual program and displaying the visual portion entirely within the second display area.

17. The method of claim 14, wherein causing the first menu item to cease to be selected further comprises ceasing to visually display the first menu item as expanded into the first display area and displaying the first menu item entirely within the racetrack menu.

18. The method of claim 13, further comprising moving the first marker among the submenu items in a manner in which the first marker snaps between being in the vicinity of one submenu item of the plurality of submenu items and being in the vicinity of another submenu item of the plurality of submenu items.

19. The method of claim 18, further comprising operating an acoustic driver to acoustically output a sound at each instance of the first marker snapping between the vicinities of the one and another submenu items.

20. The method of claim 13, further comprising in response to the first marker being caused to be displayed within the first menu item and in response to a first predetermined period of time elapsing since the an indication of at least the first manually-operable control being operated was received, causing the first menu item to cease to be selected, wherein causing the first menu item to cease to be selected comprises causing the first marker to cease to be movable among the submenu items.
